(19) United States
(12) Patent Application Publication
(10) Pub. No.: US 2013/0022659 A1
(43) Pub. Date: Jan. 24, 2013

(54) Band, bracelet or strip carrier for an anti-microbial agent to reduce the spread of disease

(71) Applicant: Roger Roberts, Orange, CA (US)

(72) Inventor: Roger Roberts, Orange, CA (US)

(21) Appl. No.: 13/136,031

(22) Filed: Jul. 22, 2011

(51) Int. Cl. A01N 25/34; A01N 65/00

(52) U.S. Cl. 424/411; 424/725

(57) ABSTRACT

A band, bracelet, strip or patch to be worn around the wrist or ankle or removably attached to the back of the wearer's hand. Each article is treated with an anti-microbial agent (e.g., tea tree oil) that is capable of killing germs and potentially harmful bacteria. The band, bracelet, strip or patch is impregnated with the anti-microbial agent during manufacture or saturated with the agent by the wearer following manufacture. The agent is delivered to the skin (e.g., the hands) of the wearer by way of either dispersion (exudation) and migration (mixed with the wearer's normal body oil) or by direct touch contact with and transmission to the wearer's fingers so as to reduce the spread of illness and disease.

### BACKGROUND OF THE INVENTION

1. Field of the Invention

This invention relates primarily to a band or bracelet of the kind that is commonly worn around the wrist or ankle of an individual. To reduce the spread of germs and potentially harmful bacteria due to hand touching, the band/bracelet is treated (e.g., impregnated or saturated) with an anti-microbial agent to be delivered from the band/bracelet to the skin (e.g., hands) of the wearer.

2. Background Art

It is well known that germs and potentially harmful bacteria are transmitted between individuals by direct hand-to-hand contact. The possibility of spreading illness and disease occurs throughout the day during contact with healthcare providers, food preparers and servers, bank tellers and co-workers. Harmful bacteria is also transmitted by touching regularly-encountered objects such as telephones, elevator buttons, ATM machines, door handles, faucets, and the like.

A common way to protect against the effects of harmful bacteria and thereby reduce the spread of disease is to regularly wash one's hands or rub a chemical germ remover or disinfectant over the hands. Unfortunately, suitable hand washing facilities and/or dispensers of disinfectant are not always available throughout the day which often leaves individuals unprotected.

Tea tree oil, or melaleuca oil, is an essential oil having a camphoraceous odor. The oil is extracted from the leaves of the Melaleuca alternifolia, which is native to the northeast coast of New South Wales, Australia. Tea tree oil is a natural antibacterial disinfectant that has long been used as a general antiseptic by aborigine tribes. It has recently been confirmed that tea tree oil is capable of providing medicinal benefits when applied topically, including antiseptic, antibacterial, antifungal and antiviral advantages. Among over 98 compounds contained in the oil, terpinen-4-ol is responsible for most of the anti-microbial activity. Tea tree oil is defined by international standard ISO 4730 (2004) (“Oil of Melaleuca, Terpinen-4-ol type”).

Despite the known benefits of tea tree oil, there is no readily-available means to enable an individual to conveniently carry this or any other suitable anti-microbial agent on his person so as to permit a small amount thereof to be delivered on a regular or as-needed basis to the skin of the individual. That is to say, what is needed is a means to be transported by the individual within which a supply of tea tree oil or the like is stored so as to be delivered either continuously or from time-to-time in order to provide the wearer with the antibacterial and germ-killing advantages for which the tea tree oil is known.

### SUMMARY OF THE INVENTION

In general terms, a band or bracelet is described of the kind to be worn around the wrist or ankle of an individual. The band/bracelet functions as a carrier for a liquid anti-microbial agent to be transported on the wearer's person and delivered to the skin (e.g., hands) of the wearer to reduce the spread of germs and potentially harmful bacteria due to hand-to-hand or hand-to-object touching. According to a preferred embodiment, the anti-microbial agent to be carried by and delivered to the wearer from the band/bracelet contains tea tree oil (or melaleuca oil) which is known to have an inherent antibacterial characteristic.

In one case, the band or bracelet is manufactured from a material that is capable of being impregnated with the liquid anti-microbial agent during manufacture. That is, the band/bracelet is pre-charged with the anti-microbial agent prior to purchase by the wearer. In a second case, the band/bracelet is manufactured from an absorbent material. Thus, the band/bracelet can be saturated with the anti-microbial agent by the wearer following purchase. The absorbent band/bracelet can be recharged by the wearer over time with a fresh supply of the anti-microbial agent. By virtue of the foregoing, small amounts of the anti-microbial agent carried by the band or bracelet can be delivered to the wearer's skin (particularly his hands) on a continuous basis by means of exudation and migration or on an as-needed basis by means of direct touch contact and transmission to the wearer's fingers.

In the case where the band or bracelet is manufactured from an absorbent, rechargeable material, a kit can be provided including a dry, uncharged carrier, a supply of liquid anti-microbial agent, and a dispenser (e.g., dropper). Following purchase, the wearer can use the dispenser to saturate the absorbent band/bracelet with the liquid anti-microbial agent from the supply thereof. After it has been worn for a time, the wearer can recharge the absorbent band/bracelet with additional amount of the anti-microbial agent from the supply.

Rather than a band or bracelet, the carrier of the liquid anti-microbial agent can also be a strip or patch to be attached to the skin or wrapped around the wearer's wrist or ankle. A series of such strips/patches may be transported on a roll and torn off one at a time.

### BRIEF DESCRIPTION OF THE DRAWINGS

FIG. 1 shows one example of a band that has been or can be treated with an anti-microbial agent to be delivered to a wearer's skin;

FIG. 2 shows one example of a bracelet that has been or can be treated with an anti-microbial agent for delivery to the wearer's skin;

FIG. 3 shows a kit including a band or bracelet like that shown in FIG. 1 or 2 in combination with a supply of liquid anti-microbial agent and a dispenser;

FIG. 4 shows a strip or patch treated with an anti-microbial agent and attached to a user's skin; and

FIG. 5 shows a roll of strips or patches like that shown in FIG. 4 to be transported and dispensed one at a time.

### DESCRIPTION OF THE PREFERRED EMBODIMENT

In a first preferred embodiment of this invention, a band or bracelet is disclosed to be positioned around the wrist or ankle of a wearer. The band/bracelet is initially treated or can be treated later with a liquid anti-microbial agent to be delivered to the wearer's skin in order to kill germs and potentially harmful bacteria. The band/bracelet may be manufactured from a variety of different materials and treated with the anti-microbial agent in different ways so long as the agent can be transferred from the band/bracelet to the skin of the wearer.

By way of one example, the band/bracelet is made from a material that is adapted to be impregnated with the liquid anti-microbial agent during manufacture. In this case, the band/bracelet is pre-charged with the agent prior to purchase by the wearer. By way of another example, the band/bracelet is made from an absorbent material so as to be charged (i.e., saturated) with the liquid anti-microbial agent by the wearer after being purchased from the manufacturer. In this same regard, and as will be described in greater detail hereinafter, a band/bracelet which is made from an absorbent material can be recharged by the wearer from time-to-time with a fresh amount of anti-microbial agent so that the germ and bacteria fighting ability thereof can be renewed.

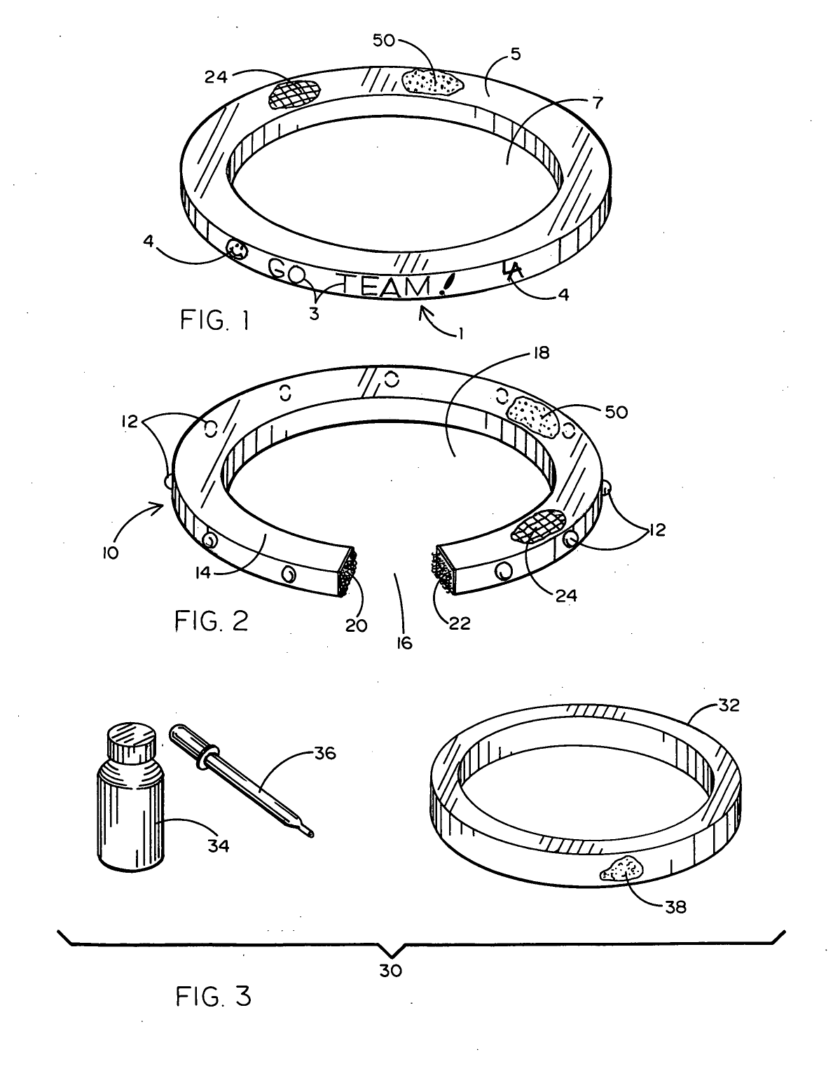

Referring now to FIGS. 1 and 2 of the drawings, examples are shown of a band 1 and a bracelet 10 which may be pre-charged by the manufacturer prior to purchase by the wearer or charged by the wearer after purchase as just explained. Thus, the band 1 and the bracelet 10 function as a carrier for the anti-microbial agent which is stored thereon and delivered therefrom. The band 1 and the bracelet 10 of FIGS. 1 and 2 are generally ring-shaped and sized to receive therewithin the wrist or ankle of the wearer. To this end, it is preferable that the band 1 and bracelet 10 be flexible to facilitate attachment to and removed from the wearer's wrist or ankle.

The band 1 and bracelet 10 may include printed or molded indicia and/or designs (designated 3 and 4 in FIG. 1) for purposes of advertising or for conveying a personal message. The band 1 and bracelet 10 can also have any color and/or scent and carry ornamental elements (such as the gemstones designated 12 in FIG. 2) by which to create a decorative effect for use as a fashion accessory. In this same regard, the band/bracelet can be coupled to a watch or key chain (not shown) or to pieces of jewelry. Therefore, different bands and bracelets, such as those designated 1 and 10 in FIGS. 1 and 2, can be worn together or independently at different times and for different events depending upon the choice and circumstances of the wearer.

The flexible band 1 of FIG. 1 has a continuous ring-shaped body 5 through which the wearer's arm or ankle is slid for receipt at an open center 7 that is surrounded by the body 5. The flexible bracelet 10 of FIG. 2 also has a ring-shaped body 14 with a break or separation 16 located therein that communicates with an open center 18 that is surrounded by the body 14. The wearer's wrist or ankle is pushed through the separation 16 in body 14 for receipt at the open center 18. The separation 16 in the body 14 of the bracelet 10 is momentarily expanded in response to the pushing force applied to the body 14 by the wearer's wrist or ankle.

Because of its flexible nature, the bracelet 10 can be worn as shown in FIG. 2 with the separation 16 in the body 14 remaining open. In situations where the separation 16 is large, it may be desirable for the user to be able to close the separation to avoid having the bracelet 10 fall off his arm or leg. In this case, strips 20 and 22 of hook-and-loop fastener material (known commercially as Velcro) can be attached to opposing ends of the body 14. When the strips 20 and 22 of fastener material are pushed into detachable mating engagement with one another, the former separation 16 in the body 14 will be eliminated, and the bracelet 10 will be closed around the wearer's wrist or ankle. Other conventional fastening means, such as snaps, ties or clasps may be used in place of the fastener strips 20 and 22 described above. Therefore, the precise manner in which the separation 16 is eliminated and the bracelet 10 is closed around the wearer's wrist or ankle is not to be considered a limitation of this invention.

In accordance with a preferred embodiment, the liquid anti-microbial agent 50 with which the band 1 or the bracelet 10 is or will be treated is tea tree oil (i.e., melaleuca oil) to be delivered to and coat the skin (particularly the hands) of the wearer. However, other liquid anti-microbial agents can be substituted for the tea tree oil. Moreover, the band 1 or bracelet 10 can be treated with a blend of different oils including tea tree oil, or the like. The anti-microbial agent will be delivered to the wearer's skin from the band or bracelet by way of either the continuous dispersion or exudation and migration (mixed with the wearer's normal body oil) of micro amounts over time or incrementally from time-to-time by direct touch contact with and transmission to the wearer's fingers. The wearer has the option of rubbing the anti-microbial agent over his hands to kill germs and potentially harmful bacteria which reside thereon.

In the case where the band 1 or bracelet 10 is impregnated with the liquid anti-microbial agent 50 during manufacture, the band/bracelet is preferably made (e.g., molded) from plastic, silicone, rubber or the like and/or a blend of materials including silver ion textiles 24. The band 1 or bracelet 10 may be impregnated with the anti-microbial agent during an extrusion manufacturing process. In the case where the band 1 or bracelet 10 is to be charged (and later recharged) with the anti-microbial agent after manufacture, the band/bracelet is preferably manufactured from an absorbent material such as, for example, cotton blends, permeable woolen materials, yarn, fabric wrapped over a plastic or silicone substrate, and the like. The absorbent material may also include silver ion textiles 24. The aforementioned silver ion textiles 24 provide the advantage of the known anti-bacterial characteristic of silver ions. Whether the band/bracelet is impregnated or saturated with the anti-microbial agent, a carrier will be available to enable the wearer to have readily-available protection against common germs and bacteria without having to waste time finding hand washing facilities or a source of chemically-based agents and disinfectants.

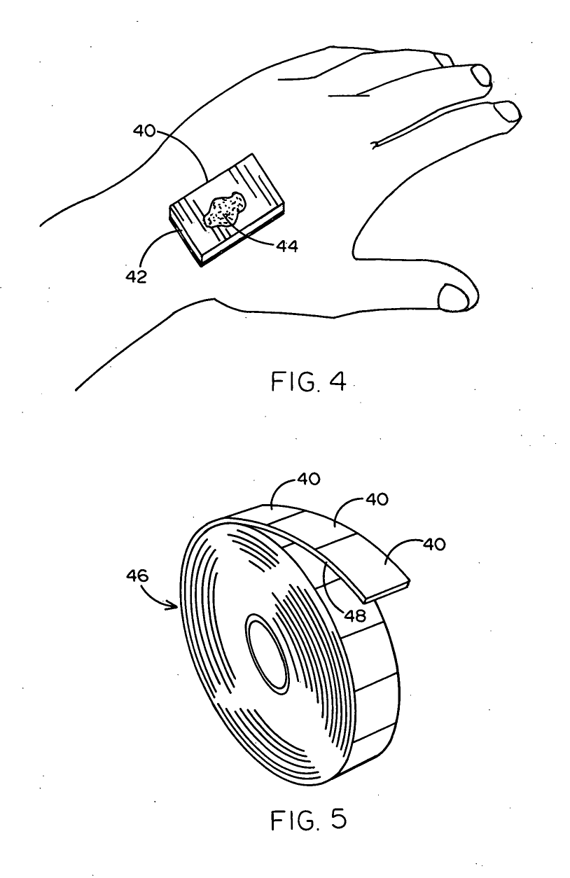

In the case where the band 1 or bracelet 10 of FIGS. 1 and 2 includes an absorbent material, a kit can be assembled and made available to permit the reuse and recharging of the band/bracelet with the liquid anti-microbial agent. Referring in this regard to FIG. 3 of the drawings, there is shown such a kit 30 including a band (or bracelet) 32 manufactured from an absorbent material, a supply 34 of liquid anti-microbial agent (e.g., tea tree oil or a blend of oils including tea tree oil, or the like), and a dispenser 36 (e.g., an “eye dropper”).

The wearer can saturate (i.e., charge) the absorbent material of the band/bracelet 32 with anti-microbial agent 38 from the supply 34 by means of the dispenser 36. The band/bracelet 32 is worn around the wearer's wrist for a period of time or during different intervals of time to permit the anti-microbial agent 38 carried by the band/bracelet to be transferred to the wearer's skin by exudation and migration or by finger touch contact as previously explained. The wearer may, from time-to-time, wish to recharge the band/bracelet 32 with a fresh supply of the anti-microbial agent by means of the dispenser 36. In this manner, the band/bracelet 32 can be reused while providing the wearer with a continuous and readily-available way to kill germs and potentially harmful bacteria.

Rather than the band or bracelet of FIGS. 1-3 to carry and dispense the anti-microbial agent, a strip or patch having a variety of shapes and sizes may also be used as a carrier. Such a strip or patch 40 is shown in FIG. 4 of the drawings. The strip/patch 40 is adhesively attached to the wearer's skin (e.g., the back of his hand or wrist) so as to be removed and discarded following a single use and replaced by a fresh strip/patch. By way of one example, the strip/patch 40 includes a base or substrate 42 that is manufactured from an absorbent material. The absorbent base 42 is treated (i.e., saturated) by the manufacturer or the wearer with a liquid anti-microbial agent (e.g., tea tree oil or a blend of oils including tea tree oil, or the like) 44 as described above. The wearer can move the fingers of his other hand into touch contact with the anti-microbial agent 44 carried in the absorbent material 42 of the strip/patch 40 to spread the agent over his skin as needed.

FIG. 5 of the drawings shows a roll 46 on which a series of peel-off strips or patches 40, like that shown in FIG. 4, are transported. The strips/patches 40 are adhesively and releasably mounted on a continuous backing 48 which is wound up to establish the roll 46. Individual strips/patches 40 are removed (i.e., pulled off) one at a time from the backing 48 to be adhesively attached to the wearer's skin wherever and whenever one is needed to receive the benefit of the anti-microbial agent 44 carried by the strip/patch.

1. A method for killing germs and potentially harmful bacteria on the skin of a user, comprising the steps of treating a carrier with an anti-microbial agent, and the user wearing the carrier against his skin so that some of the anti-microbial agent is delivered from the carrier to the user's skin by exudation and migration or by touch contact with and transmission to the user's fingers.

2. The method recited in claim 1, comprising the additional step of treating the carrier with a liquid anti-microbial agent.

3. The method recited in claim 1, including the additional step of treating the carrier by impregnating the carrier with the anti-microbial agent.

4. The method recited in claim 3, comprising the additional steps of manufacturing the carrier from an absorbent material and saturating the absorbent material with a liquid anti-microbial agent.

5. The method recited in claim 4, comprising the additional step of the user from time-to-time resaturating the absorbent material of the carrier with the liquid anti-microbial agent.

6. The method recited in claim 1, comprising the additional step of wrapping the carrier around the user's wrist or ankle.

7. The method recited in claim 1, comprising the additional step of the user removably attaching the carrier to his skin.

8. The method recited in claim 1, comprising the additional step of manufacturing said carrier to include silver ion textiles.

9. The method recited in claim 1, comprising the additional step of molding the carrier and forming ornamental indicia in said carrier during said molding step.

10. The method recited in claim 1, wherein said carrier is one of a band or a bracelet.

11. The method recited in claim 1, wherein said carrier is one of a patch or a strip.

12. The method recited in claim 1, wherein said anti-microbial agent is tea tree oil.

13. Apparatus for killing germs and potentially harmful bacteria on the skin of a user comprising a carrier to be worn by the user against his skin, said carrier treated with an anti-microbial agent that is adapted to be delivered to the user's skin by exudation and migration or by touch contact with and transmission to the user's fingers.

14. The apparatus recited in claim 13, wherein said anti-microbial agent with which said carrier is treated is a liquid anti-microbial agent.

15. The apparatus recited in claim 14, wherein said liquid anti-microbial agent is tea tree oil.

16. The apparatus recited in claim 13, wherein said carrier is impregnated with said anti-microbial agent so that said agent is continuously exuded from said carrier to migrate over the user's skin.

17. The apparatus recited in claim 13, wherein said carrier is manufactured from an absorbent material and said anti-microbial agent is a liquid, said absorbent material being saturated with said liquid anti-microbial agent.

18. The apparatus recited in claim 13, wherein said carrier is manufactured to include silver ion textiles.

19. The apparatus recited in claim 13, wherein said carrier is one of a band or a bracelet to be worn around the user's wrist or ankle.

20. The apparatus recited in claim 13, wherein said carrier is one of a patch or a strip to be removably attached to the user's skin.
